(19) United States
(12) Patent Application Publication
(10) Pub. No.: US 2015/0209770 A1
(43) Pub. Date: Jul. 30, 2015

(54) MULTIFUNCTIONAL BIOMASS PYROLYSIS CATALYST AND METHOD OF USING THE SAME

(71) Applicant: KiOR, Inc., Pasadena, TX (US)

(72) Inventors: Maria Magdalena Ramirez Corredores, Houston, TX (US); Ling Zhou, Houston, TX (US); Xiaowei Tong, Houston, TX (US); Rocio Banda, Houston, TX (US); Hollie Craig, Baytown, TX (US)

(21) Appl. No.: 14/168,787

(22) Filed: Jan. 30, 2014

(51) Int. Cl. B01J 29/80; C10G 1/00

(52) U.S. Cl. CPC B01J 29/80; C10G 1/00; B01J 2029/062

(57) ABSTRACT

A multi-functional catalyst for the conversion of biomass contains zeolite ZSM-5, zeolite USY, a metallic component, a basic material and a binder. The metallic component may be Cu, Ni, Cr, W, Mo, a metal carbide, a metal nitride, a metal sulfide or a mixture thereof. The basic material may be an alkaline-exchanged zeolite or an alkaline earth-exchanged zeolite having from about 40 to about 75% of exchanged cationic sites.

### FIELD OF THE DISCLOSURE

The disclosure relates to a multi-functional catalyst for the pyrolysis of biomass.

### BACKGROUND OF THE DISCLOSURE

Renewable energy sources are a substitute for fossil fuels and provide a means of reducing dependence on petroleum oil. Renewable fuels include biofuels. Catalytic thermolysis processes, such as pyrolysis, are typically used to deoxygenate biomass into hydrocarbon containing feedstreams for the production of biofuels. During catalytic pyrolysis, the biomass, such as a lignocellulosic based biomass, is thermally depolymerized and the depolymerized products are subjected to catalytic conversion. Dehydration and dehydroxylation of the biomass are typically the principal reactions occurring during pyrolysis. In addition, carbonyl linkages within the biomass may be broken down into carbon monoxide by decarbonylation. Decarbonylation, which typically increases in catalytic pyrolysis, decreases the yield by removing carbon bearing molecules into gaseous products.

A water-gas shift (WGS) reaction might occur during deoxygenation of the biomass wherein carbon dioxide and hydrogen are produced from the reaction of carbon monoxide and water, depending on catalyst and reaction conditions. In light of the complexity of lignocellulosic biomasses, other reactions need to be promoted within the biomass conversion unit. Such reactions include decarboxylation, oligomerization, condensation, and cyclization.

Typically, a mono-functional catalyst (e.g., an acid catalyst) is used for the multiple reactions which occur in the biomass conversion unit. Alternatively, different mono-functional catalysts have been used for various purposes, such as to modulate cracking (e.g., acids) or maximize decarboxylation to maximize carbon dioxide (e.g., bases). The use of a mono-functional catalyst to tackle the complexity of pyrolysis decreases the efficiency of conversion of the biomass to hydrocarbons and shortens the life cycle of any catalyst used within the biomass conversion unit. There is a need for an improved catalyst system that overcomes these issues for conversion of biomass and maximizes the production of liquid fuels.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

Accordingly, there exists a need for an improved catalyst for use during pyrolysis of a biomass compositions. There is also a need for alternative methods for producing hydrocarbons during the pyrolysis of a biomass feedstream.

### SUMMARY OF THE DISCLOSURE

A catalyst for the conversion of biomass is disclosed having various components which impart multiple functions. Such components include zeolite ZSM-5, zeolite USY, a metallic component, a basic material and a binder. The metallic component may be Cu, Ni, Cr, W, Mo, a metal carbide, a metal nitride, a metal sulfide or a mixture thereof. The basic material may be an alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, ceria-alumina, ceria-silica, zirconia-alumina, zirconia-silica or a mixture thereof wherein the exchanged zeolite has from about 40 to about 75% of exchanged cationic sites. The binder may be kaolin-based, alumina-based or silica-based or a combination thereof.

In another embodiment, a catalyst for the conversion of biomass is disclosed which contains zeolite ZSM-5, zeolite USY having a weight ratio of Si:Al from about 5 to about 200, L-zeolite, a metallic component, a basic material and a binder. The metallic component may be Cu, Ni, Cr, W, Mo, a metal carbide, a metal nitride, a metal sulfide or a mixture thereof. The basic material may be an alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides or a combination thereof and mixed oxides selected from the group of magnesia-alumina, magnesia-silica, titania-alumina, titania-silica, ceria-alumina, ceria-silica, zirconia-alumina, zirconia-silica or a mixture thereof wherein the exchanged zeolite has from about 40 to about 75% of exchanged cationic sites. The binder may be kaolin-based, alumina-based or silica-based or a combination thereof.

In another embodiment, a process of converting solid biomass to hydrocarbons is disclosed wherein a biomass is subjected to pyrolysis in a biomass conversion unit in the presence of a multi-functional catalyst. The multi-functional catalyst contains zeolite ZSM-5, zeolite USY, a metallic component, a basic material and a binder. The metallic component may be Cu, Ni, Cr, W, Mo, a metal carbide, a metal nitride, a metal sulfide or a mixture thereof. The basic material may be an alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, ceria-alumina, ceria-silica, zirconia-alumina, zirconia-silica or a mixture thereof wherein the exchanged zeolite has from about 40 to about 75% of exchanged cationic sites. The binder may be kaolin-based, alumina-based, silica-based or a combination thereof.

In another embodiment, a process of converting solid biomass to hydrocarbons is disclosed wherein a biomass is subjected to pyrolysis in a biomass conversion unit in the presence of a multi-functional catalyst. At least a portion of the multi-functional catalyst might be a regenerated catalyst which contains zeolite ZSM-5, zeolite USY having a weight ratio of Si:Al from about 5 to about 200; L-zeolite, a metal carbide, a basic material and a binder. The basic material may be an alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides or a combination thereof and mixed oxides selected from the group of magnesia-alumina, magnesia-silica, titania-alumina, titania-silica, ceria-alumina, ceria-silica, zirconia-alumina, zirconia-silica or a mixture thereof wherein the exchanged zeolite has from about 40 to about 75% of exchanged cationic sites. The binder may be kaolin-based, alumina-based or silica-based or a combination thereof.

### BRIEF DESCRIPTION OF THE DRAWINGS

The following figures are part of the present specification, included to demonstrate certain aspects of various embodiments of this disclosure and referenced in the detailed description herein:

FIG. 1 illustrates the process of converting solid biomass to hydrocarbons by feeding a regenerated multi-functional catalyst into a biomass conversion unit.

FIG. 2 demonstrates the lack of oxygenates in the product from a biomass sample subjected to pyrolysis in the presence of the multi-functional catalyst disclosed herein.

FIG. 3 shows the presence of oxygenates in the product from a biomass sample subjected to pyrolysis with a catalyst which is not defined by the multi-functional catalyst disclosed herein.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

The figures are not necessarily to scale and certain features and certain views of the figures may be shown exaggerated in scale or in schematic in the interest of clarity and conciseness.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. Also, the terms “including” and “comprising” are used herein and in the appended claims in an open-ended fashion, and thus should be interpreted to mean “including, but not limited to . . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Preferred embodiments of the present disclosure thus offer advantages over the prior art and are well adapted to carry out one or more of the objects of this disclosure.

The catalyst disclosed herein is a multi-functional catalyst for use in the conversion of biomass. In a preferred embodiment, the catalyst is used in biomass conversion in a single step (stage).

The disclosed catalyst provides greater versatility than the use of mono-functional catalyst during conversion of biomass. The catalyst is further capable of maximizing liquid yield of hydrocarbons in a more cost effective manner.

Thermolysis processes and other conversion processes of biomass produce high yields of bio-oil (pyrolysis oil). Such oils are of low quality due to the presence of high levels of low molecular weight oxygenates and the lack of hydrocarbons. Such oxygenates can be in alcohols, aldehydes, ketones, carboxylic acids, glycols, esters, and the like. Those having an isolated carbonyl group include aldehydes and ketones like methyl vinyl ketone and ethyl vinyl ketone.

In the multi-functional catalyst, the presence of the zeolite ZSM-5 principally promotes oligocyclization and/or aromatization of the bio-oil and/or pyrolysis oil compounds. This provides more effective use of the active sites of ZSM-5 and prevents its rapid deactivation. As such, this zeolite enables production of higher molecular weight hydrocarbons versus the low molecular weight (generally less than C₅) in bio-oil and/or pyrolysis oil produced during pyrolysis of a biomass in a biomass conversion unit.

Typically, amount of zeolite ZSM-5 in the multi-functional catalyst disclosed herein is from about 5 to about 40 wt. %.

The presence of zeolite USY in the multi-functional catalyst promotes cracking of the biomass monomers, dimers and/or small oligomers.

The amount of zeolite USY in the disclosed multi-functional catalyst is typically from about 5 to about 40 wt. %. Typically, the weight ratio of Si:Al in zeolite USY is from about 5 to about 200, more typically from about 20 to about 100.

L-zeolite may also be included with zeolite ZSM-5 and zeolite USY. When present, the amount of L-zeolite in the multi-functional catalyst is less than about 20 wt. %. Typically, L-zeolite is used to promote aromatization of hydrocarbons produced during catalytic pyrolysis in the presence of the multifunctional catalyst.

The ZSM-5 zeolite, zeolite USY and, optional, L-zeolite are included in their acid form and thus provide an acidic functionality to the multi-functional catalyst.

In some instances of catalytic pyrolysis, deoxygenating and cracking of biomass produces reactants for the WGS reaction. For instance, catalytic deoxygenation via decarbonylation and dehydroxylation produces carbon monoxide and water, respectively. The metallic component of the multi-functional catalyst promotes the WGS reaction, producing hydrogen in-situ and consequently minimizing hydrogen transfer reaction from the organic solid to the vapors.

In addition, the metallic component enhances dry reforming (DR) reaction between hydrocarbon moieties and carbon dioxide.

Suitable metallic components of the multi-functional catalyst include copper, nickel, chromium, tungsten, molybdenum, a metal carbide, a metal nitride, a metal sulfide or a mixture thereof. Suitable metal carbides include chromium carbide, molybdenum carbide and tungsten carbide as well as mixtures thereof. In a preferred embodiment, the metal carbide is molybdenum carbide.

In a preferred embodiment, the metallic component of the multi-functional catalyst is copper, nickel or a carbide of molybdenum and mixtures thereof. In another preferred embodiment, the metallic component is a blend of copper and molybdenum carbide or a blend of nickel and molybdenum carbide.

The material providing the basic functionality is preferably an alkaline-exchanged zeolite, an alkaline earth-exchanged zeolite, basic zeolite, an alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, ceria-alumina, ceria-silica, zirconia-alumina, zirconia-silica and mixtures thereof and wherein the exchanged zeolite has from about 40 to about 75% of exchanged cationic sites. In a preferred embodiment, the exchanged zeolite has 50% exchanged cationic sites. In a preferred embodiment, the basic material comprises mixed alkaline earth oxides.

The base material of the multi-functional catalyst enables decarboxylation of the biomass and thus assists its deoxygenation in the most effective manner of removing oxygen as carbon dioxide (CO₂). Where the basic material is an alkaline earth metal oxide, cerium oxide, zirconium oxide, titanium dioxide, mixed oxide of an alkaline earth metal oxide and combinations thereof or a mixed oxide selected from the group of magnesia-alumina, magnesia-silica, titania-alumina, titania-silica, ceria-alumina, ceria-silica, zirconia-alumina, zirconia-silica and mixtures thereof, the basic material may further serve to form a support or a matrix of the other components of the multi-functional catalyst. For instance, the basic material may be the support for the metallic component.

Lignocellulosic biomass contains carboxylic acids and ester-type of bonds that can be decarboxylated, providing a suitable catalyst functionality is included. Such functionality is provided by the basic material of the multi-functional catalyst. The enhanced formation of carbon dioxide from the decarboxylation reaction of biomass moieties further drives the DR reactions facilitated by the metallic component of the multi-functional catalyst.

The multi-functional catalyst defined herein may also include a binder for agglomerating the different functional entities of the catalyst and facilitating molding and/or shaping of the catalyst. Suitable binders include clay-based binders (such as kaolin), alumina-based binders (such as aluminum chlorohydrol and aluminum nitrohydrol) and silica-based binders (such as silicic acid, polysilicic acid, silica gel and colloidal silica) as well as a combination of any of such binders. In a preferred embodiment, the binder is kaolin-based. When present, the amount of binder in the multi-functional catalyst is typically less than 50 wt. %, more typically less than 30 wt. %.

The multi-functional catalyst may also include a promoter. Suitable promoters include phosphates, silica and metallic promoters and mixtures thereof. In the multi-functional catalyst, phosphate is typically used to promote the catalytic effect of the acid component in the multi-functional catalyst and to enhance the capability of the binder to agglomerate the components of the catalyst. Silica is typically used to promote the catalytic effect of the basic material. A metallic promoter is typically used to impart either a bi-metallic functionality or to stabilize the metallic component and thus enhance the performance of the metal component of the multi-functional catalyst.

Typically, the multi-functional catalyst defined herein contains from about 5 to about 40 wt. % zeolite ZSM-5; from about 5 to about 40 wt. % zeolite USY; from about 3 to about 20 wt. % of metallic material; and from about 5 to about 50 wt. % of basic material; the balance being the binder.

The multi-functional catalyst may be present in separate catalyst particles, or they may be combined in a single catalyst particle. Alternatively, different components of the catalyst system may be present in different particles.

The conversion temperature in the process disclosed is typically in the range of from 250° C. to about 700° C., more typically preferably from 300° C. to 650° C. Preferably, the biomass is heated to the conversion temperature in a fluid bed reactor. At least part of the catalyst is used as a heat carrier in the fluid bed reactor.

In an embodiment, the biomass may be pre-treated with at least one component of the catalyst system. Such a pretreatment step can comprise impregnating the cellulosic biomass with a solution of a component of the catalyst system. For this embodiment of the process, it is desirable to use for the pretreatment a catalyst component or its precursor that is soluble in water and aqueous solvents, so that an inexpensive solvent system can be used in the pretreatment step. In an alternate embodiment of the process, pretreatment is carried out with a solid catalyst component by mechanically treating the biomass in the presence of the catalyst component in particulate form. The mechanical treatment can comprise milling, grinding, kneading, or a combination thereof.

In an embodiment, the biomass particles can be fibrous biomass materials comprising cellulose. Examples of suitable cellulose-containing materials include algae, paper waste, and/or cotton linters. In one embodiment, the biomass particles can comprise a lignocellulosic material. Examples of suitable lignocellulosic materials include forestry waste such as wood chips, saw dust, pulping waste, and tree branches; agricultural waste such as corn stover, wheat straw, and bagasse; and/or energy crops such as eucalyptus, switch grass, miscanthus, coppice and fast-growing woods, such as willow and poplar.

It is advantageous to carry out the catalytic pyrolysis in a fluid bed reactor. If a fluid bed reactor is used, the catalyst particles should have a shape and size to be readily fluidized. Preferred are catalyst particles in the form of microspheres having a particle size in the range of 10 μm to 3000 μm.

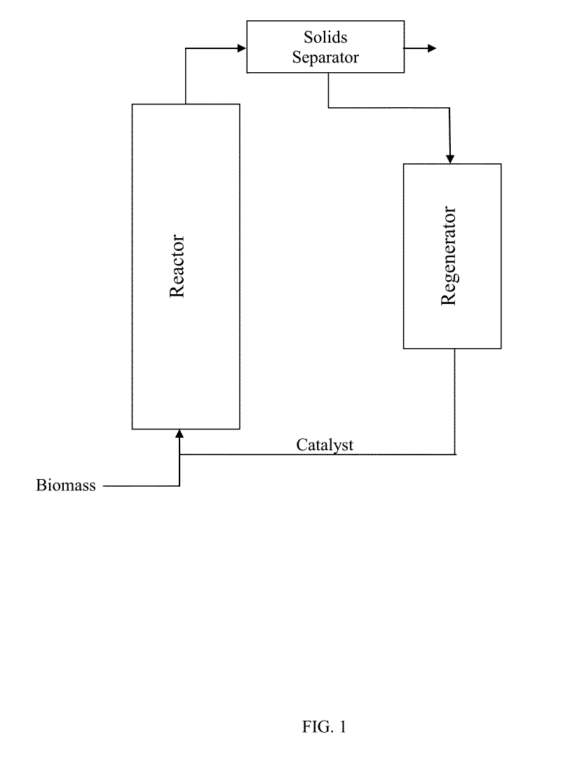

FIG. 1 exemplifies the use of the multi-functional catalyst disclosed here in the conversion of biomass to bio-oil in a single reaction step. Referring to FIG. 1, multi-functional catalyst 110 is shown as being introduced into biomass conversion unit 112 or as regenerated catalyst 115 from regeneration unit 114.

In the biomass conversion unit, the biomass may be subjected to any of a variety of conversion reactions in order to produce bio-oil. Such conversion reactions include fast pyrolysis, slow pyrolysis, liquefaction, catalytic gasification, thermocatalytic conversion, etc. Biomass conversion unit may include, for example, a fluidized bed reactor, a cyclone reactor, an ablative reactor, an auger reactor or a riser reactor. In a biomass conversion unit, solid biomass particles may be agitated, for example, to reduce the size of particles. Agitation may be facilitated by a gas including one or more of steam, flue gas, carbon dioxide, carbon monoxide, hydrogen, and hydrocarbons such as methane. The agitator further be a mill (e.g., ball or hammer mill) or kneader or mixer.

Typically, the biomass conversion unit is operated at temperatures in excess of 250° C. In some conversion reactions, such as fast pyrolysis, where the biomass is exposed to short contact times and rapid heating, reaction temperatures may be as high as 1,000° C.

The multi-functional catalyst disclosed herein may be added as fresh catalyst to the biomass conversion unit. Alternatively, the multi-functional catalyst may be an equilibrium catalyst (“E-cat”), also referred to as regenerated catalyst. Such catalysts are produced by burning coke deposits from a spent catalyst in oxygen or an oxygen containing gas, such as air, in a catalyst regeneration unit or regenerator. All or a portion of the spent catalyst formed in the biomass conversion unit may be subjected to treatment in the regenerator.

Biomass 116 introduced into biomass conversion unit 112 may be in the form of solid particles. The biomass particles can be fibrous biomass materials comprising cellulose. Examples of suitable cellulose-containing materials include algae, paper waste, and/or cotton linters. In one embodiment, the biomass particles can comprise a lignocellulosic material. Examples of suitable lignocellulosic materials include forestry waste such as wood chips, saw dust, pulping waste, and tree branches; agricultural waste such as corn stover, wheat straw, and bagasse; and/or energy crops such as eucalyptus, switch grass, miscanthus and coppice. The biomass may be in a solid or finely divided form or may be a liquid. In an embodiment, the water soluble content of the biomass is no greater than about 10 volume percent.

The biomass is thermocatalytically treated to render liquid products that spontaneously separate into an aqueous phase and an organic phase. Bio-oil (which is used to produce biofuel) consists of the organic phase. A liquid product recovery train may include more than one unit to maximize bio-oil yield such as, for instance, to more effectively partition polar compounds into the organic phase and remove any remaining solids entrained in the liquid.

Undesirable heavy materials and solids may be separated from the bio-oil in solids separator 118. Typically, from about 90 to 95 weight percent of the solids are removed from the mixture in the separator. The separator may include a coalescer, a stripper, a gravity phase separator, a liquid hydrocyclone, an electrostatic desalter, etc.

In addition to the removal of heavy materials and solids, water may be removed during the separation. The bio-oil, having the byproduct water, heavy materials and solids removed, is then introduced into fractionator 120.

Contaminated catalyst introduced into regenerator unit 114 may be a spent equilibrium catalyst (“E-cat”) and/or a fresh make-up of the multifunctional catalyst. Regenerated catalyst 115 may be produced by burning coke deposits from spent catalyst in oxygen or an oxygen containing gas, such as air.

All percentages set forth in the Examples are given in terms of weight units except as may otherwise be indicated.

### EXAMPLES

### Example 1

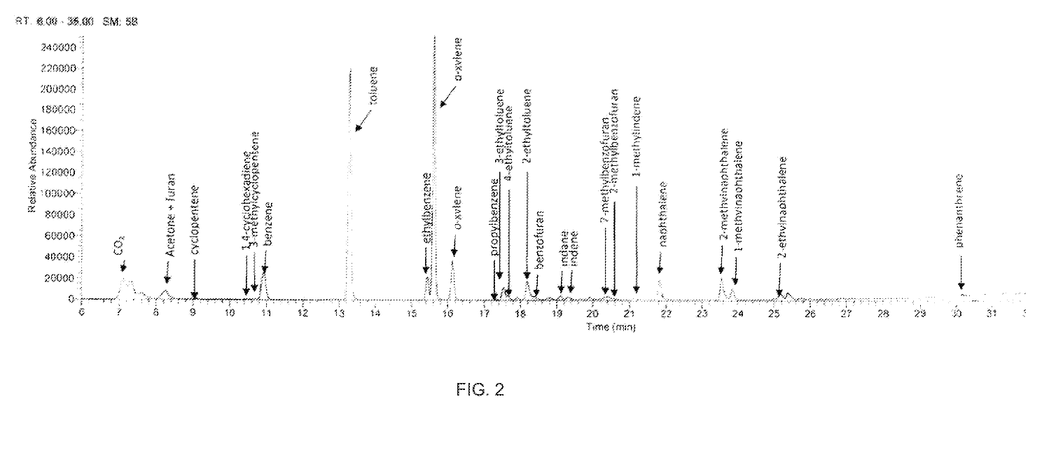

A lignocellulosic biomass was subjected to pyrolysis in the presence of a thermocatalyst and products were analyzed by GC-MS or GC-FID at various temperatures from 350° C. to 600° C. Three pulses of biomass were injected into the reactor at each condition sequentially, in order to assess the effect of time on stream. The catalyst contained 20% ZSM-5, 10% USY, 10% of molybdenum carbide, 30% of a basic material (MgO—Al₂O₃), and the balance was silica (Run 1). Product composition was determined for all pulses. FIG. 2 shows the individual peaks of products resulting from the catalytic pyrolysis of the biomass feed, for various pulses. The intensity of the individual peaks provides relative quantitative estimates of the concentration of the individual components in the biomass samples. FIG. 2 illustrates that the product is mainly composed of hydrocarbons.

### Example 2

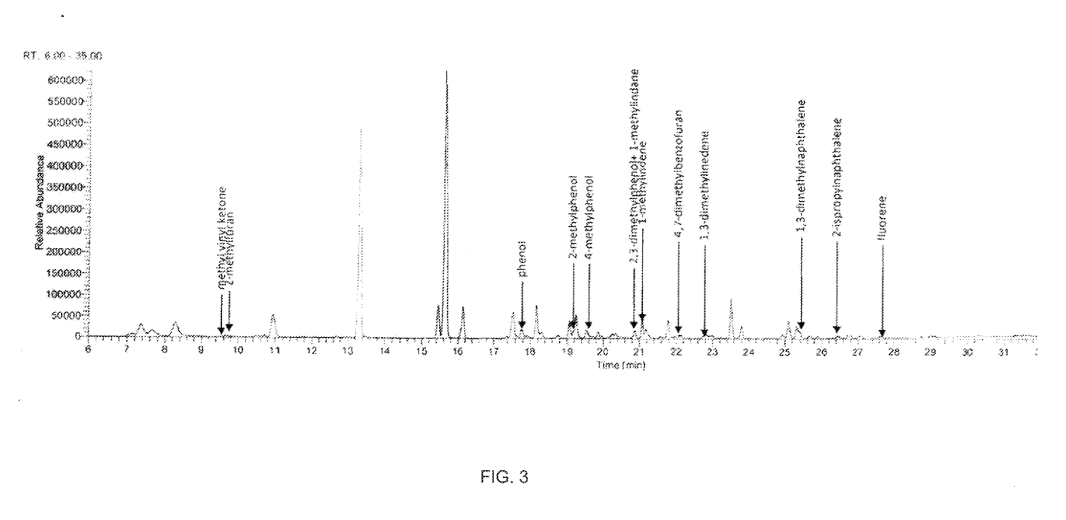

The procedure of Example 1 was repeated except the catalyst did not contain molybdenum carbide (Run 2). FIG. 3 shows that without the presence of the metallic component, the product composition changes and yield decreases with time on stream.

A summary of catalyst performance is presented in Table 1. As can be seen, the presence of the metallic component for instance provides stability for the performance of the other components of the multifunctional catalyst.

TABLE 1

| | | Run 1 | | Run 2 | |
|---|---|---|---|---|---|
| | | Intensity, | | Intensity, | |
| Pulse # | Temp, ° C. | 10⁶ counts | Remarks | 10⁶ counts | Remarks |
| 1 | 550 | 65 | High DeOx; High Decarboxyl; | 30 | High DeOx; High |
| 2 | | 70 | No Deact | 24 | Decarboxyl; 30% Deact |
| 3 | | 60 | | 20 | |
| 4 | 500 | 30 | High DeOx; Low Decarboxyl; | 14 | Low DeOx; No Decarboxyl; |
| 5 | | 35 | No Deact | 8 | Faster Deact |
| 6 | | 24 | | 7 | |
| 7 | 400 | 11 | High DeOx; Med Decarboxyl; | 6 | Med DeOx; No Decarboxyl; |
| 8 | | 14 | No Deact | 5.5 | Select Deact |
| 9 | | 10 | | 4 | |
| 10 | 450 | 16 | Med DeOx; High Decarboxyl; | 8 | Med DeOx; Med |
| 11 | | 20 | No Deact | 7 | Decarboxyl; Fast Deact |
| 12 | | 20 | | 5 | |
| 13 | 550 | — | — | 6 | Overall deact: 5x |

While exemplary embodiments of the disclosure have been shown and described, variations and modifications of the multi-functional catalyst within the scope of the appended claims, and may be made and used by one of ordinary skill in the art. Thus, the Examples above should be interpreted as illustrative and the scope of the disclosure and the appended claims should not be limited to the embodiments described and shown herein.

What is claimed is:

1. A catalyst for the conversion of biomass, the catalyst comprising:
a) zeolite ZSM-5;
b) zeolite USY;
c) a metallic component selected from the group consisting of Cu, Ni, Cr, W, Mo, a metal carbide, a metal nitride, a metal sulfide and mixtures thereof;
d) a basic material selected from the group consisting of alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, ceria-alumina, ceria-silica, zirconia-alumina, zirconia-silica and mixtures thereof and wherein the exchanged zeolite has from about 40 to about 75% of exchanged cationic sites; and
e) a binder wherein the binder is kaolin based, alumina based or silica based or a combination thereof.

2. The catalyst of claim 1, wherein the weight ratio of Si:Al in zeolite USY is from about 5 to about 200.

3. The catalyst of claim 2, wherein the weight ratio of Si:Al in zeolite USY is from about 20 to about 100.

4. The catalyst of claim 1, wherein the metallic component is a metal carbide selected from the group of chromium carbide, molybdenum carbide and tungsten carbide and mixtures thereof.

5. The catalyst of claim 4, wherein the metal carbide is molybdenum carbide

6. The catalyst of claim 1, further comprising L-zeolite.

7. The catalyst of claim 1, further comprising a promoter selected from the group consisting of phosphates, silica and metallic and mixtures thereof.

8. The catalyst of claim 1, wherein the metallic component is comprised of copper, nickel or a carbide of molybdenum or a mixture thereof.

9. The catalyst of claim 8, wherein the metallic component is a blend of copper and molybdenum carbide or a blend of nickel and molybdenum carbide.

10. The catalyst of claim 1, comprising from about 5 to about 40 wt. % zeolite ZSM-5; from about 5 to about 40 wt. % zeolite USY; from about 3 to about 30 wt. % of metallic material; and from about 5 to about 50 wt. % of basic material; the balance being the binder.

11. The catalyst of claim 10, wherein the basic material is an exchanged zeolite having 50% exchanged cationic sites.

12. The catalyst of claim 10, wherein the catalyst further comprises less than 20 wt. % of L-zeolite.

13. The catalyst of claim 1, wherein the binder comprises kaolin.

14. The catalyst of claim 1, comprising from about 5 to about 40 wt. % zeolite ZSM-5; from about 5 to about 40 wt. % zeolite USY; from about 5 to about 50 wt. % of basic material; from about 3 to about 30 wt. % of a blend of copper and the carbide of molybdenum or from about 3 to about 30 wt. % of a blend of nickel and the carbide of molybdenum; and the balance being the binder.

15. The catalyst of claim 1, wherein the metallic component is selected from the group of Cu, Ni, Cr, W, Mo, a metal carbide, a metal nitride, a metal sulfide and mixtures thereof and is supported by the basic material.

16. A catalyst for the conversion of biomass, the catalyst comprising:
a) zeolite ZSM-5;
b) zeolite USY having a weight ratio of Si:Al from about 5 to about 200;
c) L-zeolite;
d) a metallic material comprising a metal carbide;
e) a basic material selected from the group consisting of alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, ceria-alumina, ceria-silica, zirconia-alumina, zirconia-silica and mixtures thereof and wherein the exchanged zeolite has from about 40 to about 75% of exchanged cationic sites; and
f) a binder comprising a material selected from the group consisting of kaolin, alumina, silicic acid, polysilicic acid, silica gel, aluminum chlorohydrol, aluminum nitrohydrol and combinations thereof.

17. The catalyst of claim 16, further comprising a promoter selected from the group consisting of phosphates, silica and metallic and mixtures thereof.

18. The catalyst of claim 16, wherein the weight ratio of Si:Al in zeolite USY is from about 20 to about 100.

19. The catalyst of claim 16, wherein the metal carbide is selected from the group of chromium carbide, molybdenum carbide and tungsten carbide

20. The catalyst of claim 16, wherein the metallic component is supported by the basic material.

21. A process of converting solid biomass to hydrocarbons comprising the step of feeding into a biomass conversion unit the catalyst of claim 1 and pyrolyzing the biomass in the biomass conversion unit.

22. The process of claim 21, wherein at least a portion of the catalyst fed into the biomass conversion unit is regenerated catalyst.
